(19) United States
(12) Patent Application Publication
(10) Pub. No.: US 2006/0234641 A1
(43) Pub. Date: Oct. 19, 2006

(54) System for using an existing cellular network to detect incidents of GPS jaming

(75) Inventor: Richard Thomas LaGrotta, Livingston, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/049,765

(22) Filed: Feb. 3, 2005

(51) Int. Cl. H04B 17/00

(52) U.S. Cl. 455/67.13

(57) ABSTRACT

A system for detecting incidents of GPS signal jamming utilizes one or more cellular telecommunications networks where GPS signals are received at various geographically dispersed base stations for timing or synchronization purposes—e.g., certain CDMA-based mobile phone networks. Each base station is outfitted with a data routing subsystem that routes data relating to interruptions in the received GPS signal, as detected by the base station, to a real time national database. The database stores and processes the received data, and is configured to be accessed by government or other officials for assessing GPS interference across the geographic area covered by the cellular network(s). The GPS interruption/interference data may be graphically displayed, and it may be correlated with other relevant data.

### FIELD OF THE INVENTION

The present invention relates to telecommunications and, more particularly, to systems for detecting signal jamming or interference, especially of the global positioning system (“GPS”).

### BACKGROUND OF THE INVENTION

The global positioning system (“GPS”) is a satellite navigation system used for determining an end user's position on the Earth's surface. The GPS includes a number of medium earth orbit satellites that transmit encoded time signals down towards the Earth. Each satellite has an on-board atomic clock for generating the encoded time signal, and the satellites are synchronized to one another through radio communications to one or more ground control stations. GPS receivers (e.g., portable electronic devices carried by the end users) receive and decode the time signals from multiple (e.g., four or more) satellites, and the end user's latitude, longitude, and elevation are calculated from these signals using trilateration algorithms. The GPS receivers also calculate the local time based on the received time signals as modified by any necessary correction factors.

Aside from equipment costs, accessing the GPS is free of charge, and it is used by individuals and commercial entities for easily and quickly determining position and time. The GPS is especially important to the aviation industry, where it is used for navigation and air traffic control, and to the military, which uses the GPS for navigation, weapons systems control, force deployment coordination, and the like.

Because GPS satellite signals are relatively weak at the receiver end, GPS receivers are potentially vulnerable to interference or jamming. Intentional interference may result from terrorist activity (e.g., transmitting noise across the GPS frequency band using an electronic jamming device), while unintentional interference may arise as a byproduct of operating commercial or consumer electronics. In either case, it may be vital for public safety and military and homeland security to detect such interference as quickly and accurately as possible. Since the interference is localized, detection is made difficult over large geographic areas. Moreover, interference detection relies either upon expensive portable electronic units, or upon reports from affected end users. Such interference detection methods may be unreliable and provide alerts after the damage or disruption to end user activities have already occurred.

### SUMMARY OF THE INVENTION

A system for detecting incidents of GPS signal jamming or interference includes one or more existing cellular networks (e.g., mobile networks), a data routing subsystem operating on each of the network's base stations, and a real time national database in communications with the base stations. The existing cellular network is deployed over a large geographic area (e.g., a national mobile phone network), and is of the type where GPS signals are already received and utilized by the network's base stations for purposes internal to the network, such as timing and synchronization purposes.

In operation, the network's base stations receive GPS signals on an ongoing basis. If the GPS signal is jammed or otherwise interfered with at one of the base stations, this is detected by the base station, and the data routing subsystem routes data relating to the interruption or interference to the national database. Subsequently, government or other officials can access the national database for assessing GPS interference across the geographic area covered by the cellular network. The database may process the data/information received from the base stations for statistical, archival, and/or user interface purposes—e.g., categorization and mapping of the data to a computer-displayed map of the geographic area. Additionally, alerts may be sent to the government officials warning them of possibly significant events or occurrences.

### BRIEF DESCRIPTION OF THE DRAWINGS

The present invention will be better understood from reading the following description of non-limiting embodiments, with reference to the attached drawings, wherein below:

FIG. 1 is a schematic diagram of a system according to an embodiment of the present invention;

FIG. 2A is a flowchart illustrating the monitoring of a GPS signal according to an embodiment of the present invention;

FIG. 2B is a flowchart illustrating data processing in a national database portion of the system shown in FIG. 1; and

FIG. 3 is a schematic diagram showing a more detailed view of a data routing subsystem portion of the system shown in FIG. 1.

### DETAILED DESCRIPTION

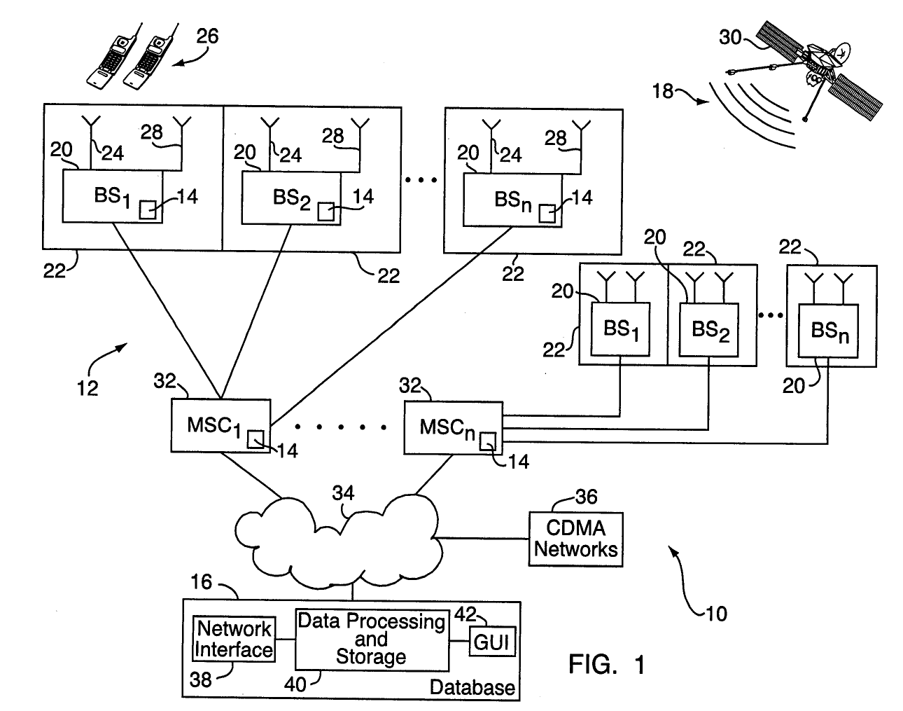

With reference to FIGS. 1-3, one embodiment of a system 10 for detecting incidents of global positioning system (“GPS”) jamming or interference includes an existing cellular telecommunications network 12 (mobile phone network), a data collection or routing subsystem 14 operating as part of or in conjunction with the network 12, and a real time national database system 16 in communications with the data subsystem 14 and/or network 12. The existing cellular network 12 is deployed over a large, possibly nationwide geographic area, and is of the type where GPS signals 18 are already received and utilized by the network's various base stations 20 for purposes internal to the network 12. Suitable networks in the United States include those that use the CDMA (code division multiple access) spread spectrum multiplexing scheme as specified in the “IS-95”, “IS-2000”, or other standards. Hereinafter, any cellular network that utilizes and/or detects GPS signals is referred to as a “CDMA network,” regardless of the particular communications scheme or protocol used—i.e., CMDA-based or otherwise.

In operation, in the system 10, the network's base stations 20 receive GPS signals 18 on an ongoing basis, as part of their normal course of operation. The base stations 20 are configured to detect interruptions or interference in the GPS signals 18, and data relating to any instances of interference (e.g., such as duration and geographic location) is routed by the data subsystems 14 to the national database 16. Officials from the U.S. Department of Homeland Security or other government agencies are able to access the national database 16 for assessing GPS interference across the geographic area covered by the CDMA network 12. The interference data may be electronically processed or analyzed by the database 16 for statistical, archival, and/or user interface purposes, including categorization and mapping of data to a computer-displayed rendition (e.g., map) of the geographic area. As should be appreciated, the term “interference” includes interference, jamming, blocking, and the like, be it partial or total, intentional or inadvertent.

According to typical cellular network topologies, the CDMA network 12 is geographically divided into a number of cells 22, which are typically contiguous and which together define the coverage area of the network 12. Each cell 22 is served by one of the base stations 20, which includes one or more fixed/stationary transceivers and antennae 24 for wireless communications with a set of distributed mobile stations 26 (e.g., mobile phones, “cell phones,” or wireless units) that provide service to the network's users. Each base station 20 also has a standard GPS receiver 28 configured to receive GPS signals 18 from one or more GPS satellites 30 in Earth orbit. The base stations 20 are in turn connected (e.g., either wirelessly or through land lines) to a number of mobile switching centers (“MSC”) 32, each of which serves a particular number of base stations depending on network capacity and configuration. The mobile switching centers 32 act as the interface between the wireless/radio end of the CDMA network 12 and a public switched telephone network or other network(s) 34, including performing the signaling functions necessary to establish calls or other data transfer to and from the mobile stations 26.

In the CDMA network 12, the GPS signals 18 received by the base stations 20 are used to generate the precise timing data necessary to effectively implement synchronized CDMA communications, including synchronization between the various base stations 20. For example, the IS-95 standard specifies that base stations should be synchronized to within a few microseconds of each other, and that the period or “epoch” of PN codes (e.g., used to implement CDMA and other spread spectrum communications) be within seven microseconds of UTC time. Without proper timing data, the communications algorithms used by the CDMA network 12 do not function correctly.

Because of the importance of GPS signals to the CDMA network 12, the base stations 20 are provided with local clocks that are used in the event of a GPS interruption or failure. For example, most base stations 20 have the capability of maintaining synchronization accuracy for up to twenty-fours hours if the GPS signal 18 is lost or if the GPS receiver 28 malfunctions. Additionally, in the event of GPS signal failure at one of the base stations 20 (e.g., due to problems in the GPS receiver 28 or to GPS signal interference), the base station 20 issues a maintenance alert or notification to the network's operators alerting them to the situation. Typically, the alerts are forwarded to whichever service personnel are responsible for remedying the situation at the base station(s) where the GPS signal failure has occurred. However, in some instances the alerts may not be received, as a result of being dropped due to throttling, or because of other system limitations.

Additionally, in the system 10, the data routing subsystems 14 are configured to cause copies of the alerts, and/or additional or other GPS interference data, to be routed to the real time national database 16. The data routing subsystems 14 may be stand-alone or integrated electronic modules. More typically, each subsystem 14 will comprise a set of software or firmware subroutines (e.g., computer programs) operating on a base station's existing computer/electronic systems (e.g., base station controller), in parallel or in conjunction with the base station's existing operations. For example, the data routing subsystems 14 may take the form of one or more scripts (e.g., sequences of instructions carried out by the base station controller) that cause the GPS interference data to be routed to the national database 16 in addition to the network owner/operator.

Typically, the GPS interference data will be sent using the CDMA network's existing protocols and infrastructure, just as if it were data being sent to and from the mobile stations 26. For example, the system 10 may take advantage of the CDMA network's existing ability to connect a mobile station 26 to the Internet. In such a case, the GPS interference data would be converted by the base stations and/or mobile switching centers, as applicable, into a stream of IP (Internet protocol) packets addressed to the database, according to the particular standards in place on the network 12 for handling such matters.

The GPS jamming/interference data includes information allowing the database 16 to determine the location of the base station where the interruption has occurred, as well as an indication of the duration of the interference. The GPS interference data may be a continuous signal generated while the interference is present, or it may comprise various intermittent signals indicating the start and stop of the interference. Additional information may also be supplied, either through the base stations' normal operations or through additional functionality provided by the data routing subsystems 14, including further or more detailed information as to the nature and extent of the GPS signal interference, e.g., complete blockage, partial blockage, and GPS signal strength at the receivers 28. In other words, the data routing subsystems 14 may simply cause copies of the alerts or alarms normally generated by the base stations upon GPS signal interference to be sent to the database 16, or the data routing subsystems 14 may augment the alerts/alarms with additional information, or they may generate entirely separate GPS interference data.

As indicated in FIG. 1, all of the CDMA network's mobile switching centers 32 are in communications with the national database 16. This arrangement provides coverage across the CDMA network's geographic area. The connection to the national database 16 may be a dedicated direct channel or line, or it may be one or more existing networks 34 to which the CDMA network 12 is already connected. Examples include the public switched telephone network and the Internet. Also, to provide coverage beyond a single CDMA network 12, and regional, national, and even multi-national coverage, additional CDMA networks 36 may be appropriately configured (e.g., outfitted with the data routing subsystems 14) and connected to the national database 16.

The real time national database 16 is a computer-based data processing and storage program running on a computer or computer system configured to access the network(s) 34. For example, the database 16 could be implemented on a server computer connected to the Internet and having its own unique URL (e.g., web address). The database 16 includes a communications module or network interface 38 for interfacing with the network 34, a data processing and storage module 40 for processing and storing data relating to each cell or base station in the CDMA network(s) 12, 36, and a user interface 42, all of which may be implemented using standard database, data processing, and Internet technology.

In operation, the database 16 receives GPS interference data from the one or more CDMA networks 12, 36 and processes the data in real time, as fast as it is received, and as needed for use by government officials or other end users. For example, the database 16 could simply store the data and issue alerts in the event of GPS signal interruptions. Alternatively, the database 16, through the user interface 42, could generate a rendition of the geographic area covered by the CDMA networks 12, 36, such as a map of the U.S. or a portion thereof, along with showing the locations of the base stations 20 and/or the boundaries of the cells 22. Additionally, a graphical representation of the GPS status of each cell 22 or base station 20 could be shown, such as coloring a displayed cell or base station location green if the GPS interference data indicates that the received GPS signal in the cell is within normal parameters, coloring a cell yellow if the GPS signal in the cell is outside normal parameters, and coloring a cell red if the GPS signal in the cell is completely blocked. As should be appreciated, in most CDMA networks, the data routing subsystems 14 would be configured to send information to the database 16 only in the event of an interruption in the received GPS signals. In such a case, the database 16 would be set up to assume that GPS signals are being properly received at each base station unless the database receives GPS interference data from the subsystems 14 to the contrary.

Additional functionality (e.g., graphically displayed or otherwise) could be implemented on the database 16 for allowing officials or other end users to access additional information about the GPS status of each cell or base station location, such as the duration of GPS signal interference in a particular cell or group of cells. Also, because GPS signal interference may be non-continuous but periodic, such as terrorists attempting to interfere with GPS signal reception at an airport only at night, the database 16 could be configured to display historical or time averages or patterns of GPS signal interference not necessarily apparent on a purely “real time” display.

The database 16 may also be configured for correlating the GPS signal data with other relevant data or information, and for displaying the relationship with respect to a map or other graphical representation. For example, along with displaying base station or cell locations and the GPS signal status at each such location, any of the following could also be displayed: population density, geographical features and landmarks, the location of sensitive or critical installations such as military bases and airports, or any other information relating to the geographic area covered by the CDMA network 12 (collectively, “correlation data”).

As indicated above, there are many possible modes of data processing and display for the database 16. According to one embodiment, the database 16 would be set up to allow users, through access to a command-based or graphical user interface, to select among a number of different functions and data display modes. For example, a user could choose to query the database, run reports, view raw or processed stored data, or to view the GPS signal status at the cells/base stations according to a number of different possible modes: real time, historical averages or patterns, with respect to correlation data, etc.

The database 16 may be directly accessed by authorized officials on the server computer or a secure LAN only and not over a public network, or the database 16 may be accessed over the network 34 using a secure website or the like. For example, various authorized personnel could be given accounts and passwords for accessing the database 16 over the Internet from their respective offices or other remote locations. The database 16 could also be configured to take proactive steps in alerting officials to possible problems, including sending email messages and issuing text messages to registered officials' mobile phones.

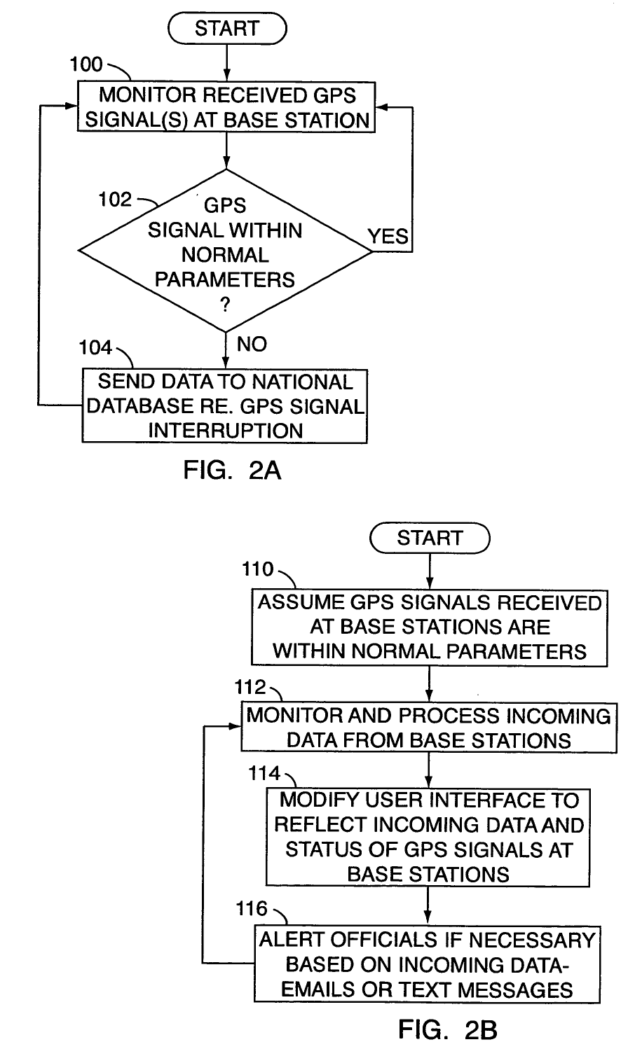

FIG. 2A summarizes one possible embodiment of the GPS signal monitoring functionality in place on the base stations 20 in the system 10. As indicated at Step 100, the base station 20 monitors the status of the received GPS signal. In Step 102, it is determined whether or not the received GPS signal is within normal parameters, based on signal strength, quality, or the like. If the received GPS signal is not within normal or expected parameters, at Step 104, interference data reflecting that fact is sent to the national database 16. Subsequently, the base station 20 continues to monitor the received GPS signal, as at Step 100.

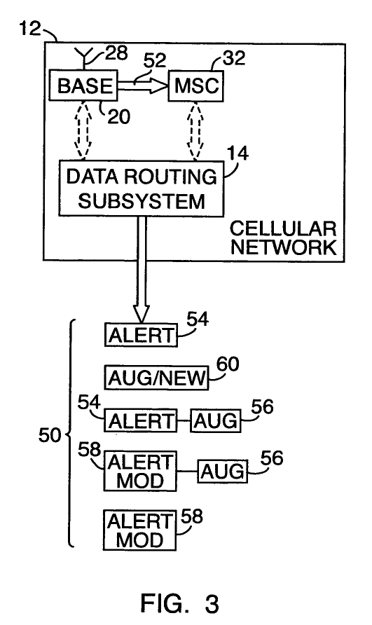

With reference to FIG. 3, for routing interference data 50 to the national database 16, the data routing subsystem(s) 14 could be put in place at the base stations 20, or at other locations in the network(s) 12, 36 such as the mobile switching centers 32, depending on the particular characteristics of the networks. For example, if the base stations 20 are configured to send maintenance alerts 52 to the MSC's 32, each MSC 32 could be outfitted with a data routing subsystem 14 for identifying the alerts and forwarding copies to the database 16. In short, the cellular network 12 is outfitted with one or more data routing subsystems 14 that interact with one or more portions of the cellular network 12 such as the base stations 20 or MSC's 32.

As further indicated in FIG. 3, the interference data 50 routed to the national database 16 may simply be a copy 54 of the maintenance alert 52. As should be appreciated, routing a copy 54 to the national database ensures that it is brought to the attention of officials, as opposed to the actual alerts 52, which may be subject to internal network limitations, and which are only directed to maintenance personnel or network operators. The interference data may take other forms. For example, the interference data 50 may be a copy 54 of the maintenance alert plus augmentation data 56, where the augmentation data is information relating to the GPS signal interference or otherwise, in addition to the information included in the maintenance alert. For example, if the maintenance alert only includes the base station location and an indication that the base station has switched to its local clock, the augmentation data could include information as to the nature of the GPS signal interference, e.g., local equipment failure, partial interference, and total blockage. The interference data 50 may also be a modified version 58 of the maintenance alert, meaning that the maintenance alert is somehow modified or changed from its original form as issued by the base station. Also, a modified version 58 of the alert plus augmentation data 56 may be combined to form the interference data 50. Further, the interference data may be a newly generated message 60 completely separate from the alert 52. Thus, the data routing subsystem 14, configured to interact or interface with one or more portions of the cellular network 12, will cause interference data 50 to be routed to the national database 16, where the interference data 50 comprises a copy 54 of the base station alert, and/or some modified or augmented version thereof, or a completely new message, as generated by the data routing subsystem 14. By “generated,” it is meant that the data routing subsystem 14 produces or manipulates the interference data 50, or some portion thereof, prior to causing it to be routed to the database 16.

The operation of the national database 16, according to one possible embodiment, is summarized in FIG. 2B. At Step 110, the database starts in a baseline or initial configuration, where it is assumed that the received GPS signals at the base stations 20 or cells 22 within the network(s) 12, 36 are within normal parameters. At Step 112, the database 16 monitors and processes data received from the base stations 20 by way of the data routing subsystems 14. Then, at Step 114, and based on the data received from the base stations, the database 16 modifies the database or data storage contents relating to each cell or base station from which data is received, as well as the user interface. In other words, the database 16 receives, processes, and stores data received from the base stations, and then modifies the user interface based on the received/processed data, in a manner that depends on the particular user interface implemented on the database 16, be it a GUI/map, query database or search engine, text interface, or the like. Optionally, at Step 116, the database 16 issues alerts to officials or other registered end users using email, text messages, voice messages, etc. Then, back at Step 112, the database 16 continues to monitor and process incoming data.

Because the system 10 utilizes a CDMA network's existing GPS receivers 28, and because a number of CDMA networks are already in place across most, if not all, of the United States, the system 10 can be implemented relatively quickly and inexpensively, while providing coverage across very wide geographical areas. Moreover, centralized, wide-area, real time monitoring, as implemented in the regional/national database 16, allows officials to detect instances of GPS interference or jamming much more quickly and effectively, and possibly before any negative consequences result from the GPS signal interference.

As noted, the global positioning system utilizes several ground control stations located at various positions around the world for broadcasting orbital data, clock correction, and/or synchronization signals to the GPS satellites, and for tracking and monitoring the satellites. Because the base stations 20 present an array of additional fixed GPS receivers capable of forwarding the received GPS signals 18 through the cellular network 12, it is contemplated that the system 10 may be used to augment the existing GPS ground control stations, for purposes of further increasing the accuracy and/or functionality of the GPS generally. In such a case, the data routing subsystems 14 would be configured to send the GPS signals received at the base stations 20 to the database 16 or to another location relevant to the GPS, such as the GPS master control facility located at Schriever Air Force Base in Colorado for example. Because of the sheer number of existing base stations, and because the GPS signals are continuous, it is likely that only a sampling of the GPS signals would be required for augmenting the GPS ground control stations. In other words, forwarding all the received GPS signals on a continuous basis (e.g., versus sending a smaller sample) would likely not provide a significant enough advantage in light of the required data bandwidth. Sampling could be accomplished by having only a subset of the base stations forward the received GPS signals, and/or by sending periodic samples of the received GPS signals themselves instead of continuous signals, e.g., one sample per hour or day from all the base stations, or some portion thereof.

Optionally, the base stations 20 and/or data routing subsystems 14 may be configured to detect GPS signal “spoofing.” Spoofing involves the transmission of a false GPS signal that mimics an actual GPS signal, but that contains incorrect timing information, position information, or the like. Spoofing may be detected by comparing the information in received GPS signals to expected information. For example, since the base stations 20 are stationary (e.g., with a known, static position), incorrect positioning information can be detected by comparing each base station's known position to a position calculated from the received GPS signals. The same holds true in comparing received timing information to a local base station time, where a large enough discrepancy would suggest a spoofed GPS signal instead of mere time drift. For this or other purposes, the data routing subsystems 14 may be configured to monitor the GPS signals received at the base stations 20 in parallel to the instrumentation (e.g., software and/or hardware) already in place on the base stations for doing so.

Since certain changes may be made in the above-described system for using an existing cellular network to detect instances of GPS signal jamming or interference, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A system for detecting global positioning system (GPS) signal interference at a cellular network base station, said system comprising:
a data router configured to cause interference data to be routed to a database if the base station issues a GPS alert, wherein the interference data relates to GPS signal interference detected at the base station.

2. The system of claim 1 wherein the interference data comprises a copy of the GPS alert issued by the base station.

3. The system of claim 2 wherein the data router is further configured to generate augmentation data as part of the interference data, said augmentation data comprising information in addition to the information included in the GPS alert.

4. The system of claim 1 wherein the interference data comprises a modified version of the GPS alert issued by the base station.

5. The system of claim 1 wherein the data router is configured to generate the interference data.

6. The system of claim 1 wherein the data router is configured to route to at least one of the database and a control center of the global positioning system at least a sampling of the GPS signals received by the base station.

7. The system of claim 1 wherein the database is in communication with the cellular network for receiving interference data from all of a plurality of base stations of the cellular network.

8. The system of claim 1 wherein the data router is configured for interfacing with the base station.

9. The system of claim 8 wherein the data router comprises a computer program configured to run on a base station controller portion of the base station.

10. The system of claim 1 wherein the data router is configured to cause the interference data to be converted into IP packets according to a protocol, said IP packets including an address for transmitting the IP packets to the database.

11. The system of claim 1 wherein the data router is configured to cause interference data to be routed to the database when one or more of a plurality of cellular network base stations issues a GPS alert, wherein the interference data relates to GPS signal interference respectively detected at said one or more base stations.

12. The system of claim 11 wherein the interference data comprises copies of the GPS alerts issued by the one or more base stations.

13. The system of claim 11 wherein the data router is configured to generate the interference data, said interference data being at least partly different from GPS alerts issued by the one or more base stations.

14. A database system for use in detecting global positioning system (GPS) signal interference at a plurality of cellular network base stations, said database system comprising:
a data processing module configured to process received interference data, said interference data relating to GPS signal interference detected at the plurality of base stations; and
a user interface configured for facilitating access to the database system, for assessing the GPS signal interference across a geographic area covered by the cellular network.

15. The database system of claim 14 wherein the user interface is further configured to display a graphical rendition of the geographic area covered by the cellular network, to display on the graphical rendition the locations of the plurality of base stations, and to display at the location of each respective base station a status of the received GPS signals at the respective base station.

16. The database system of claim 15 wherein the user interface is further configured to display correlation data on the graphical rendition.

17. The database system of claim 14 wherein the data processing module is further configured to determine a time pattern of the interference data, for assessing patterns of GPS signal interference over time.

18. The database system of claim 14 wherein the user interface is further configured to generate an Internet website for remote access to the processed interference data over the Internet.

19. The database system of claim 14 further comprising a network interface for connecting the database to receive the interference data from said at least one cellular network across the Internet.

20. A system for detecting global positioning system (GPS) signal interference at a cellular network base station, said system comprising:
a database; and
data routing means for causing interference data to be routed to the database if the base station issues a GPS alert, wherein the interference data relates to GPS signal interference detected at the base station.
